(19) United States
(12) Patent Application Publication
(10) Pub. No.: US 2009/0092837 A1
(43) Pub. Date: Apr. 9, 2009

(54) MAGNETIC BEADS

(75) Inventors: Andreas Axen, Uppsala (SE); Eva Holmgren, Uppsala (SE); Nils Norrman, Uppsala (SE); Tobias E. Soderman, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, UPPSALA (SE)

(21) Appl. No.: 12/282,650

(22) PCT Filed: Mar. 20, 2007
(86) PCT No.: PCT/SE2007/000273

§ 371 Date: Sep. 12, 2008

(30) Foreign Application Priority Data
Mar. 30, 2006 (SE) 0600742-1

(51) Int. Cl. B32B 5/16; B05D 7/00

(52) U.S. Cl. 428/407; 427/213.34; 427/213.31

(57) ABSTRACT

The present invention relates to magnetic beads in the form of composite beads with an inner core of metal particles, which are coated with an inert synthetic polymer and thereafter a hydrophilic porous polymer, preferably dextran. This provides porous biocompatible beads without metal leakage. This construction also allows for simple and convenient handling of cell expansion media by magnetism.

### FIELD OF THE INVENTION

The present invention relates to magnetic beads suitable for, for example, cell expansion.

### BACKGROUND OF THE INVENTION

Stem cell therapy is compelling because it promises potential treatments for many of today's most devastating diseases, including diabetes, cardiac disease, cancer, metabolic diseases and diseases related to ageing, such as Alzheimer's disease and osteoarthritis.

A critical enabling technology for the success of cell therapy is ESC (embryonic stem cell) expansion. Commercially available ESC expansion media include Cytodex 1 and Cytodex 3 from Amersham Biosciences AB.

Recently an increased number of products referred to as magnetic beads and a number of products for efficient handling of these products have been presented. Magnetic bead technologies are used for diverse purposes such as isolating nucleic acids and proteins as well as viruses and whole cells. The adaptability and speed of this technique makes it ideal for high-throughput applications e.g. in 96 wells micro titre plates. The technique is also applicable for large scale applications, such as chromatography applications in liquid magnetically stabilised fluidised beds.

The magnetic beads are most commonly used in combination with attached ligands having affinity for different substances. The most commonly encountered examples are metal chelating ligands (of IMAC type) intended for use in combination with His-tags and glutathione intended for use in combination with GST (Gluthathione S transferase). Other examples are a variety of different IgG's with different specificity.

Preparation of beads encapsulating metallic materials and applications of magnetic beads has been described previously. Preparing magnetic beads where the bead is built up of different layers of material has also been presented earlier.

U.S. Pat. No. 5,834,121 describes composite magnetic beads. Polymer coated metal oxide particles that are encapsulated in a rigid and solvent stable polymer of vinyl monomers in order to retain the metal oxide particles during harsh conditions. The primary beads are enclosed in a micro porous polymer bead which is capable of swelling in organic solvents and allowing for further functionalisation in order to be useful for organic synthesis. This procedure is aiming for hydrophobic beads.

U.S. Pat. No. 6,204,033 describes preparation of polyvinyl alcohol-based magnetic beads for binding bio molecules. Preparation of magnetic beads by polyvinyl alcohol in water containing magnetic particles. The final beads contain hydroxyl functionalities that can be further derivatized in order to couple bio molecules. It is claimed that these magnetic beads can be grafted with vinyl monomers carrying various functional groups.

EP 0179039 describes polymer coated metal surfaces. Dextran carrying imino diacetate groups are allowed to attach to a metal surface. Several rounds of activation and coupling of dextran is required to build up a particle. To the dextran various ligands can be attached.

In spite of the relatively large number of magnetic beads described today, there is a need of improved magnetic beads for cell expansion. There is a need of biocompatible magnetic beads intended for cell expansion/cultivation which are free of metal leakage that might have a negative effect on the cells. Especially, it is desired to enable the expansion of ESC's in the defined differentiation status and to separate the cells from the micro carrier/surface. There is also a need of providing micro carriers/surfaces in a user-friendly and safe format.

### SUMMARY OF THE INVENTION

The present invention provides cross linked dextran beads which may be provided with desired surface properties for, for example, cell expansion and which at the same time possess magnetic properties. These beads are obtained by emulsification using cellulose acetate butyrate, cellulose acetate, cellulose propionate or cellulose acetate phthalate as emulsifier. This emulsifier is after cross linking found in the surface of the bead giving the dextran bead in part the character of a cellulose bead. This bead is further derivatised depending on the intended purpose.

These magnetic beads offer the potential for handling the material by magnets e.g. for pull down during washing procedures or transfer of beads and cells to new vessels.

This invention provides micro carriers/surfaces which enable the expansion of ESC's in a defined differentiation status combined with the technology to separate the cells from the micro carrier/surface. Furthermore, the micro carriers/surfaces are user-friendly and in a safe format.

The present invention relates to a novel construction that provides a magnetic beaded material constructed in such a way that low metal leakage is combined with a hydrophilic, biocompatible outer core suitable for, for example, cell expansion.

According to the present invention magnetic metal oxide particles are coated in an inert synthetic polymer and subsequently the particles are coated with a porous outer layer of dextran. This coating procedure provides magnetic beads with low risk of leakage of metal ions even at harsh conditions, in combination with a hydrophilic, bio compatible outer layer.

Thus, in a first aspect the present invention provides magnetic beads, comprising metal particles made of, for example, metals, metal oxides and/or alloys. The magnetic beads comprise a coating of an inert synthetic polymer surrounding the metal particles and an outer coating of a porous layer surrounding the inert coating(s), wherein the outer coating is produced using an emulsifying agent that in part gives the bead the character of a cellulose bead.

Preferably the emulsifying agent is chosen from cellulose acetate butyrate, cellulose acetate, cellulose propionate or cellulose acetate phthalate, most preferably cellulose acetate butyrate.

The magnetic core of the magnetic bead comprises at leas one magnetic particle and may comprise 2-5 coated magnetic particles enclosed in each bead.

Preferably, the inner coating is made of cross linked polystyrene, for example poly(divinyl benzene), but other synthetic polymers such as cross linked poly(methacrylates) or polyacrylates can be used. This coating prevents metal leakage from the magnetic metal particles.

According to the invention the outer coating is made of a natural or synthetic hydrophilic polymer. Hydrophilic properties are very important for obtaining higher absorption capacity, biocompatibility, and prevention of unspecific interactions.

Preferably, the outer coating is made of dextran. Other examples are agarose and carbohydrate polymers, such as cellulose. Further alternatives of hydrophilic coatings are poly(vinyl alcohol) or polyacrylamides.

The particle diameter of the total bead is 5-1000 μm, preferably 20-400 μm, most preferably 50-150 μm.

In a preferred embodiment the inner coating is made of poly(divinylbenzene) and the outer coating is made of dextran using and emulsifying agent that in part gives the bead the character of a cellulose bead.

Preferably, the outer coating is provided with ligands having affinity for a desired biomolecule. Alternatively, the outer coating is provided with a surface suitable for cell expansion, such as a suitable coating and/or suitable ligands. Preferred examples are a collagen coating and low charge DEAE ligands.

In a preferred embodiment of the invention, the magnetic metal particles are made of Fe₃O₄, the inner coating is made of poly(divinylbenzene), the outer coating is made of dextran. The pore size of the bead composite is 1 nm-60 μm, preferably 50-500 nm.

In a second aspect, the invention relates to a method of producing magnetic beads, comprising the following steps

a) treating magnetic metal, metal oxide or alloy particles with an amphiphilic agent such as SDS or oleic acid;
b) adding a polymerisable monomer and a radical initiator to the treated magnetic particles;
c) emulsifying the monomer/particle mixture in an aqueous phase and polymerising the monomer by increasing the temperature to obtain polymer-coated magnetic particles;
d) adding a hydrophilic polymer to the polymer-coated magnetic particles;
e) emulsifying the polymer-coated magnetic particles into the hydrophilic polymer; and
f) derivatizing the outer layer of the hydrophilic polymer.

The derivatisation in step f) may be with any desired ligand or with any other suitable surface modification for the desired purpose, such as cell expansion purposes.

In the above method it is preferred that, the magnetic metal oxide particles are Fe₃O₄, the chemically inert polymer is poly(divinylbenzene), and the hydrophilic polymer is dextran, and that the emulsifying agent in part render the bead the character of a cellulose bead.

In a third aspect, the invention relates to use of the magnetic beads described above for separating, concentrating or analysing a biomolecule. The biomolecule may be selected from a peptide, protein, carbohydrate, nucleic acid, plasmid, virus or cell.

In a preferred embodiment, the magnetic beads are used for cultivating cells after suitable derivatisation of the outer layer. The invention is not restricted to cultivation of any special kind of cell and may for example be selected from the group consisting of mammalian cells, stem cells or bacterium. The preferred cells are stem cells, such as embryonic stem cells.

### BRIEF DESCRIPTION OF THE FIGURES

FIG. 1 shows poly(DVB)-particles with encapsulated magnetic beads; and

FIG. 2 shows dextran beads with encapsulated beads according to FIG. 1.

### DETAILED DESCRIPTION OF THE INVENTION

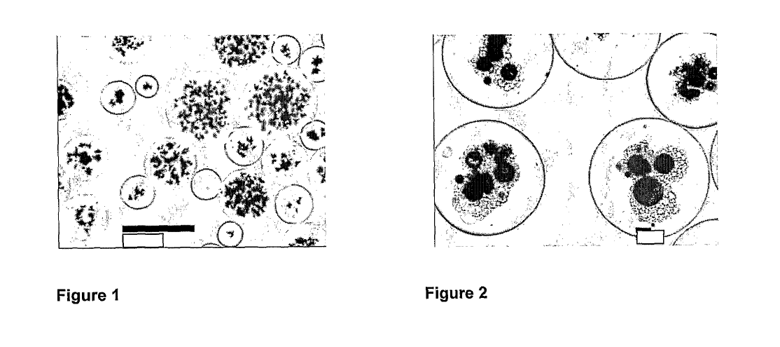

Two different magnetic materials have been used in the currently prepared magnetic dextran beads. One is magnetite particles without any coating (FIG. 1, left) and the other is magnetite particles that have been coated with DVB, using an emulsification procedure (FIG. 1, right). The former material offers a straight forward approach and is apparently simple to handle during the dextran emulsification procedure, but the final material will most likely be afflicted with metal leakage. The DVB encapsulated material will offer a final material less prone to metal leakage but introduces one extra step to the preparation procedure.

The present inventors have found that encapsulated magnetic materials can be introduced into hydrophilic, porous materials such as dextran. In a preferred embodiment, the magnetic material is encapsulated in small cross linked polystyrene beads that are used as core particles in the preparation of dextran beads.

This approach results in beads that are chemically stable towards metal leakage and at the same time posses an outer layer that offers a more suitable environment for cell expansion.

### EXPERIMENTAL PART

### 1. Materials and Methods

### Synthesis of Magnetic Poly(Divinyl Benzene) Particles

5 g of iron oxide powder (particle size <5 μm) is added to 50 mL of oleic acid in an Ehrlenmeyer flask. The flask is left on a shaking table at room temperature for an hour. The iron oxide is allowed to sediment, and as much as possible of the oleic acid is removed by decantation.

0.4 g 2,2′-azobis(2-methylbutyronitrile) (AMBN) is dissolved in 20 g divinyl benzene (DVB), tech. 80%, and after complete dissolution of the initiator, the iron oxide particles are added.

A 4% Methocel K-100 (w/v) solution is prepared in advance.

85 g of the methocel solution is added to a 250 mL three-necked round-bottom flask, followed by the organic phase prepared as above. The stirring speed is set at 175 rpm. After 30 minutes the reactor is immersed in an oil bath set at 70 degrees, and the polymerisation reaction is left overnight.

The product particles are sedimented a number of times in water, to remove fines. The particles are then washed on a glass filter with water, 5 M HCl and ethanol. No yellow colour (indicating iron leakage) was observed during the acid wash.

According to the invention, the method used for the preparation of magnetic poly(divinyl benzene) beads is suspension polymerisation. An important step in the preparation is that the magnetic entity, such as iron oxide powder, is pre-treated with an amphiphilic agent, such as oleic acid, which will render the material more hydrophobic so as to be dispersable in the divinyl benzene phase during synthesis.

This synthesis method uses emulsification of an oil-in-water suspension. This method results in a highly magnetically active material where the magnetite (Fe₃O₄) particles, are encapsulated within the bead (FIG. 1). This means that the risk of leakage at acid pH is minimised, since the poly(divinyl benzene) is chemically inert at all pH commonly used in chromatography (pH 1-14). This material is suited as the basis for further coating with a hydrophilic polymer, e.g. dextran or a hydrophilic synthetic polymer, resulting in a magnetic material encapsulated in the chemically stable poly(DVB)-material and with an external hydrophilic layer (FIG. 2).

### Hydrophilisation of Magnetic Poly(Divinyl Benzene) Beads

5 g of 2,2′-azobis(dimethylbutyronitrile) (Fluka 11596) was dissolved in 200 g of diethylene glycol monovinyl ether. Nitrogen was flushed through the solution for 30 minutes. 15 g of magnetic poly(divinylbenzene) beads as prepared in example 1 were added. The temperature was raised to 70° C. and the reaction was left overnight. The magnetic particles were washed with a 50% (v/v) ethanol in water solution.

### Encapsulation of Iron Oxide Powder (Particle Size <5 μm) in Dextran Beads

A solution of 209 ml water, 9.4 g sodium hydroxide, 0.46 g sodium borohydride and 94.3 g Dextran TF (molecular weight 150000-250000 g/mol) (GEHC) was heated to 50° C. and thereafter mixed with 20 g iron (II, III) oxide powder (Aldrich, particle size <5 μm).

A solution of 12.0 g cellulose acetate butyrate (can be obtained from several commercial sources, e.g. Aldrich) and 200 ml dichloroetane, was heated to 50° C. in a 1 litre reactor. The stirring speed was set to 100 rpm. The mixture above was added to this solution and thereafter the speed was increased to 160 rpm. When an acceptable particle size, as judged by ocular analysis using a microscope, was achieved, 12.8 ml epichlorohydrin (can be obtained from several commercial sources, e.g. Aldrich) was added. The reaction was left over night at the same stirring speed and temperature.

The formed beads are then washed repeated times with acetone and thereafter with water.

### Encapsulation of Magnetic DVB Beads in Dextran Beads

A solution of 105 ml water, 4.7 g sodium hydroxide 0.23 g sodium borohydride and 47.1 g Dextran TF (molecular weight 150000-250000 g/mol) was heated to 50° C. and thereafter mixed with 6 g dry sucked magnetic DVB particles as prepared in example 2.

A solution of 6.0 g cellulose acetate butyrate and 100 ml dichloroetan, was heated to 50° C. in a 1 litre reactor. The stirring speed was set to 100 rpm. The mixture above was added to this solution and thereafter the speed was increased to 125 rpm. When an acceptable particle size, as judged by ocular analysis using a microscopy, was achieved 6.4 ml epichlorohydrin was added. The reaction was left over night at the same speed and temperature.

The formed beads are then washed repeated times with acetone and thereafter with water.

Thereafter the emulsion was cooled and the beads were allowed to gel. The beads were washed with water and ethanol and enriched using a magnet. Approximately half of the dextran beads formed contained magnetic DVB beads. These dextran beads contain at least one inner bead of magnetic DVB, preferably 2-5.

### Further Derivatisation of the Dextran Beads

The outer dextran layer is also suited for further derivatisation with any desirable compound that fulfils the needs for the intended application, i.e. cell expansion.

For cell expansion purposes, the derivatisation is preferably with collagen or low density DEAE ligands, according to conventional methods.

1: Magnetic bead, comprising magnetic particle(s) enclosed by a coating of an inert synthetic polymer and an outer coating of a porous layer, wherein the outer coating is cross-linked and produced using an emulsifying agent that is found in the surface of the bead after cross-linking.

2: The magnetic bead of claim 1, wherein the magnetic particle(s) are made of magnetic metal, metal oxide and/or alloy particles.

3: The magnetic bead of claim 2, wherein 2-5 coated magnetic particles are enclosed in each bead.

4: The magnetic bead of claim 1, wherein the emulsifying agent is cellulose acetate butyrate, cellulose acetate, cellulose propionate or cellulose acetate phtalate

5: The magnetic bead of claim 1, wherein the inner coating is made of cross linked polystyrene, poly(methacrylates) or polyacrylates.

6: The magnetic bead of claim 1, wherein the outer coating is made of a natural or synthetic hydrophilic polymer.

7: The magnetic bead of claim 6, wherein the outer coating is made of dextran, cellulose, agarose, poly(vinyl alcohol) or polyacrylamides.

8: The magnetic bead of claim 1, wherein the particle diameter is 5-1000 μm, preferably 20-400 μm, most preferably 50-150 μm.

9: The magnetic bead of claim 1, wherein the inner coating is made of crosslinked polystyrene, preferably poly(divinylbenzene), and the outer coating is made of dextran.

10: The magnetic bead of claim 1, wherein the outer coating is derivatised.

11: The magnetic bead of claim 10, wherein the outer coating is derivatised with low density DEAE-ligands or a collagen coating.

12: The magnetic bead of claim 1, wherein the magnetic metal particles are made of Fe₃O₄, the inner coating is made of poly(divinylbenzene), the outer coating is made of dextran.

13: A method of producing magnetic beads, comprising:
a) treating magnetic metal, metal oxide or alloy particles with an amphiphilic agent;
b) adding a polymerisable monomer and a radical initiator to the treated magnetic particles.
c) emulsifying the monomer/particle mixture in an aqueous phase and polymerising the monomer by increasing the temperature to obtain polymer-coated magnetic particles.
d) adding a hydrophilic polymer to the polymer-coated magnetic particles; and
e) emulsifying the polymer-coated magnetic particles into the hydrophilic polymer to form magnetic beads.

14: The method of claim 13, comprising a further step f) derivatizing the outer layer.

15: The method of claim 13, wherein the magnetic metal oxide particles are Fe₃O₄, the chemically inert polymer is divinylbenzene, and the hydrophilic polymer is agarose.

16: The method of claim 13, wherein the emulsifying agent is selected from cellulose acetate butyrate, cellulose acetate, cellulose propionate or cellulose acetate phthalate

17-21. (canceled)
